(19) United States
(12) Patent Application Publication
(10) Pub. No.: US 2007/0291642 A1
(43) Pub. Date: Dec. 20, 2007

(54) NAS system and information processing method for the same

(75) Inventor: Masaru Orii, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/502,524

(22) Filed: Aug. 11, 2006

(30) Foreign Application Priority Data
Jun. 16, 2006 (JP) 2006-167896

(51) Int. Cl. H04J 1/16

(52) U.S. Cl. 370/222

(57) ABSTRACT

Enhancing expansion of a NAS system without restrictions from a communication network. In the NAS system having existing NAS units and disk storage apparatuses, when adding another NAS unit and disk storage apparatus to expand the system, FC ports of the NAS units are loop-connected to one another via an FC loop.

### CROSS-REFERENCES TO RELATED APPLICATIONS

This application relates to and claims priority from Japanese Patent Application No. 2006-167896, filed on Jun. 16, 2006 the entire disclosure of which is incorporated herein by reference.

### BACKGROUND

1. Field of the Invention

The invention relates generally to a NAS system having a plurality of NAS units connected to a communication network, transmitting/receiving information to/from them, and controlling access to storage device, i.e., hard disks; and it also relates to an information processing method for the NAS system.

2. Description of Related Art

Conventionally, systems where cluster-structured controllers (NAS units) are connected to client computers via LANs (Local Area Networks)—communication networks—have been known as NAS (Network Attached Storage) systems. One of those NAS systems is described in Japanese Patent Laid-Open (Kokai) Publication No. 2005-275893.

For these NAS systems, there has been demand for an increased number of connected clients and expanded storage capacity in accordance with the increase in the number of ports and the amount of data managed. In order to meet this demand, current NAS systems have to be expanded. As a solution, the foregoing Japanese Patent Laid-Open (Kokai) Publication No. 2005-275893 proposes a structure where the number of ports is increased by using gateways and additional NAS units are connected to a LAN network.

### SUMMARY

A NAS system can be expanded (system expansion, port expansion, and storage expansion) by adopting a structure where additional NAS units are added to a LAN network. However, this structure is not sufficient for optimal system operation because there are limitations on the data transfer performance of the LAN, response to failures, and maintenance operations.

This invention aims to provide a NAS system that can be easily expanded without restrictions from communication network; and a method for controlling such a NAS system.

In order to achieve the foregoing goal, this invention provides a NAS system having a plurality of NAS units that communicate with a host system via a network and process information involved in the communication; and a plurality of storage apparatuses that transmit/receive information with the NAS units and control the access to the storage devices. Each NAS unit has a network port connected to the communication network and a backend port connected to the adjacent NAS units, i.e., the backend ports of the respective NAS units are connected to one another.

According to this invention, the respective NAS units have backend ports in addition to the network ports (LAN ports). Accordingly, by connecting those backend ports to one another, the system can be expanded (system expansion, port expansion, storage expansion) easily without restrictions on the data transfer performance from the communication network, e.g., the LAN. If the backend ports of the NAS units are Fibre Channel (FC) ports, these FC ports can be loop-connected to one another to expand the system. Alternatively, if the backend ports of the NAS units are cable input/output ports, these ports can be serially connected to one another via a PCI (Peripheral Component Interconnect) Express cable, thereby expanding the system.

Of the NAS units, one is configured as a master NAS unit and the rest are configured as slave NAS units. The master NAS unit transmits/receives information with the slave NAS units via the backend ports based on the system information, managing the slave NAS units collectively. This enables efficient use of the resources in the system and enhances the system performance. Moreover, when a failure occurs in the system, the master NAS unit identifies the faulty port based on the system information and optimal recovery measures are taken so ongoing operations can continue.

Accordingly, this invention provides a NAS system that can be expanded easily without restrictions on the data transfer performance from the communication network.

### BRIEF DESCRIPTION OF THE DRAWINGS

FIG. 1 is a block diagram showing a NAS system according to Embodiment 1 of this invention.

FIG. 2 is an explanatory diagram of the content of information added to a command.

FIG. 3 is a block diagram showing a NAS system according to Embodiment 2 of this invention.

FIG. 4 is a flowchart explaining FC failure recovery processing.

FIG. 5 is a flowchart explaining LAN failure recovery processing.

FIG. 6 is a flowchart explaining OS failure recovery processing.

FIG. 7 is a flowchart explaining load-balancing processing.

FIG. 8 is a block diagram showing the situation where respective NAS units are PCI-connected to each other.

FIG. 9 is a diagram showing the structure of a monitor information table used in each NAS system.

FIG. 10 is a block diagram showing a NAS system according to Embodiment 3 of this invention.

FIG. 11 is a block diagram showing a NAS system according to Embodiment 4 of this invention.

### DETAILED DESCRIPTION OF PREFERRED EMBODIMENTS

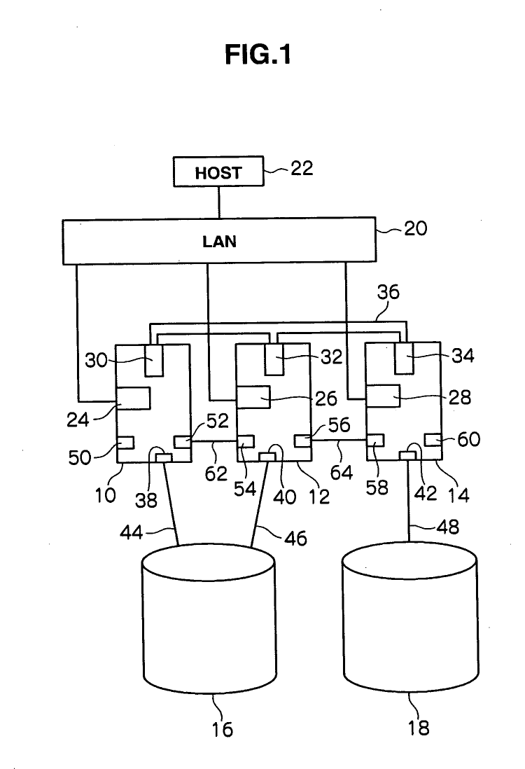

Embodiments of this invention will be explained with reference to the attached drawings. FIG. 1 is a block diagram showing a NAS system according to Embodiment 1 of this invention. In FIG. 1, a NAS system has, in addition to existing NAS units 10 and 12, a NAS unit 14 that is added to expand the NAS system, and it also has a disk storage apparatus 16 connected to the NAS units 10 and 12 and a disk storage apparatus18 connected to the NAS unit 14. The NAS units 10, 12 and 14 communicate with a host system—a communication target—via a communication network, e.g., the LAN 20 and process information related to the communication. The LAN 20 is connected to the host system (host computer) 22. The NAS units 10, 12 and 14 have LAN ports 24, 26 and 28, respectively, which are network ports connected to the LAN 20. They also have FC (Fibre Channel) ports 30, 32 and 34, respectively, which are backend ports for connection to the adjacent NAS units. The respective FC ports 30, 32 and 34 are loop-connected via an FC loop 36 made from fibres, and have bypass functions in case of port failures. The NAS units 10, 12 and 14 each have a CPU for processing various kinds of information and memory for storing various kinds of information. One of these NAS units 10, 12, 14 is structured as a master NAS unit and the others are structured as slave NAS units. In this structure, the master NAS unit sends dedicated commands to the slave NAS units via the FC loop 36 and monitors responses, thereby collectively managing the information for the slave NAS units. One of the slave NAS units may be structured as a backup NAS unit.

When setting one of the NAS units 10, 12 and 14 as a master NAS unit and the others as slave NAS units, the one having the youngest AL-PA (Arbitrated Loop Physical Address) is selected as a master NAS unit. When designating the selected NAS as a master, the AL-PA of its FC port is set to ‘FE.’ The AL-PA of the FC port of a backup NAS unit is set to ‘FC’ so that it can back up data when a failure occurs in the storage apparatus in a subsystem. Normally, the additional NAS unit 14 is structured as a sub NAS unit to constitute a subsystem.

The NAS units 10, 12 and 14 have storage interfaces 38, 40 and 42, respectively. These storage interfaces 38, 40 and 42 are connected to disk storages 16 or 18 via PCI express busses 44, 46 and 48. The disk storage apparatuses 16 and 18 are each structured having a plurality of clusters. Each cluster has a CPU, cache memory and hard disks. Each cluster transmits/receives information to/from the NAS units and controls access to its hard disks.

The NAS units may alternatively have, as backend ports, cable input/output ports 50, 52, 56, 58 and 60 and the ports 52 and 54 are connected to each other via a PCI express cable 62 and the ports 56 and 58 are connected to each other via a PCI express cable 64, thereby connecting the NAS units 10, 12, and 14 to one another. In this case also, one of the NAS units 10, 12 and 14 is configured as a master and the others are configured as slave or sub NAS units and the master NAS unit collectively manages information for the other NAS units.

In the case where the master NAS unit collectively manages information for the other NAS units, if the NAS unit 10 is a master, the system including the NAS unit 10 and disk storage 16 is set as a master NAS system, the system including NAS unit 12 and disk storage system 16 is set as a subsystem, and the system including the NAS system 14 and disk storage 18 is set as a backup NAS system, and the master NAS system collectively manages the information for these subsystems. Here, the master NAS system collects the information for the subsystems using dedicated commands.

In order to collect information for the subsystems, dedicated SCSI (Small Computer System Interface) commands are used. The master NAS system issues dedicated SCSI commands to the subsystems via the FC loop 36 or PCI cable 62 or 64; and collects responses to these commands, thereby collectively managing the information for the subsystems.

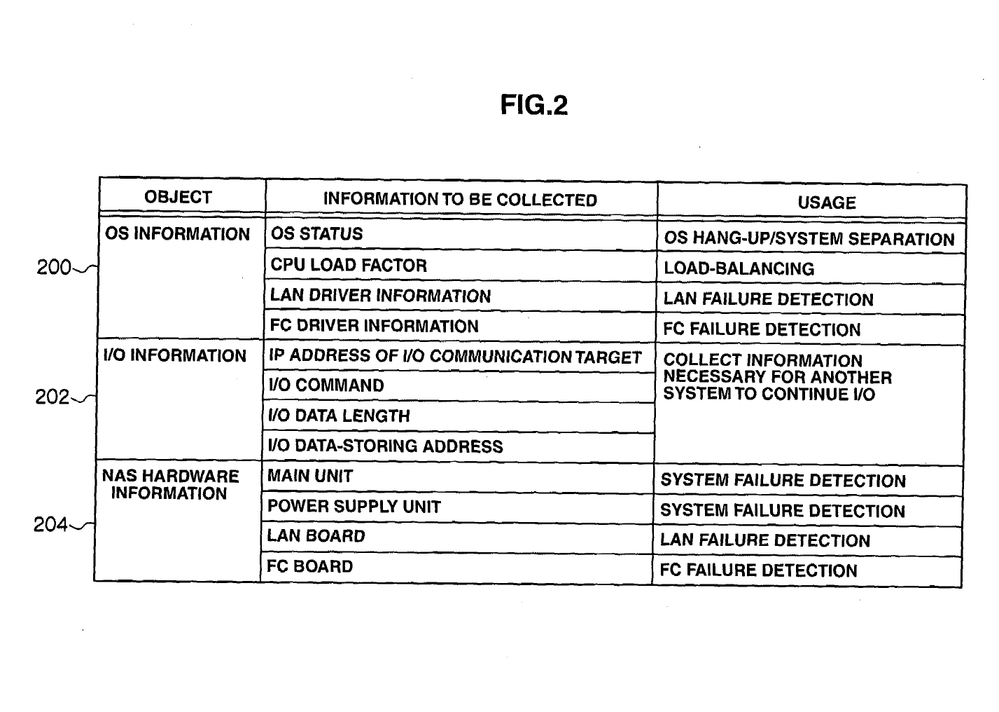

Examples of information added to a dedicated SCSI command include OS information 200, I/O information 202, and NAS hardware information 204, as shown in FIG. 2.

The OS information 200 is used for collecting information regarding an OS status (whether the OS operates normally or not), CPU load factor, LAN driver information, and FC driver information. The obtained OS status is used for OS hang-up/system separation; the CPU load factor is used for load balancing; the LAN driver information is used for LAN failure detection; and the FC driver information is used for FC failure detection. The I/O information 202 is used for collecting: an I/O communication destination, e.g., IP address of the host 22; I/O command; I/O data length; and I/O data-storing address. This information is used for collecting information necessary for the other systems to continue I/O. The NAS hardware information 204 is used for collecting information for a main unit housed in a NAS unit, a power supply unit, a LAN board, and an FC board. The obtained information for the main unit is used for system failure detection, the information for the power supply unit is also used for system failure detection, the information for the LAN board is used for LAN failure detection, and the information for the FC board is used for FC failure detection.

In this embodiment, when adding the NAS unit 14 to the existing NAS units 10 and 12 to expand the NAS system, the NAS units are connected to one another by connecting their FC ports 30, 32 and 34 to one another via the FC loop 36; or by connecting the cable input/output 52 and 54 to each other via the PCI express cable 62 and connecting the cable input/output ports 56 and 58 each other via the PCI express cable 64. Thus, the NAS unit 14 can be easily added without restrictions on the data-transfer performance from the LAN 20.

Also, according to this embodiment, because the NAS unit 10 or 12 is set as a master NAS unit, it can collectively manage the information for other NAS units.

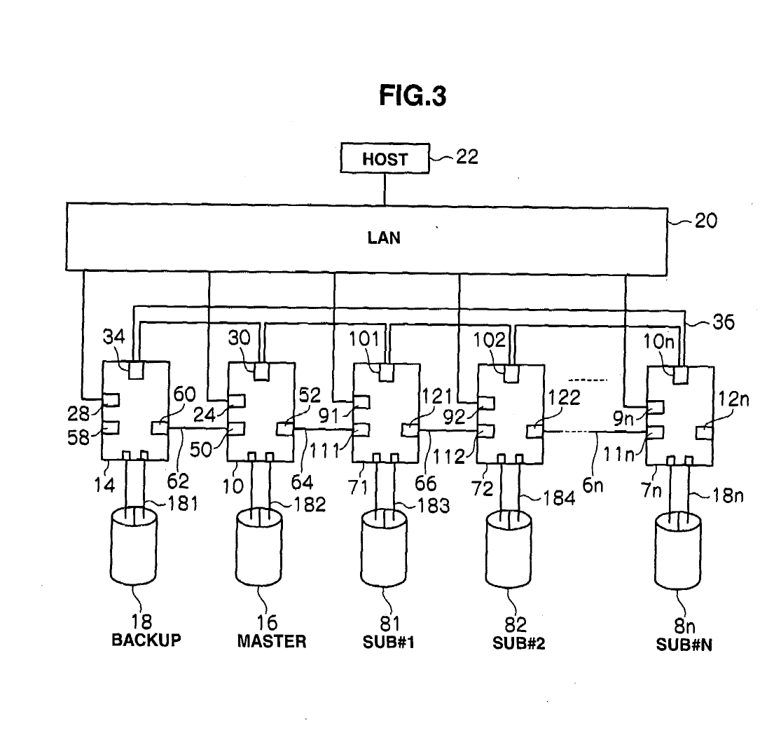

Embodiment 2, showing recovery of the NAS system from system failure, is explained below with reference to FIG. 3.

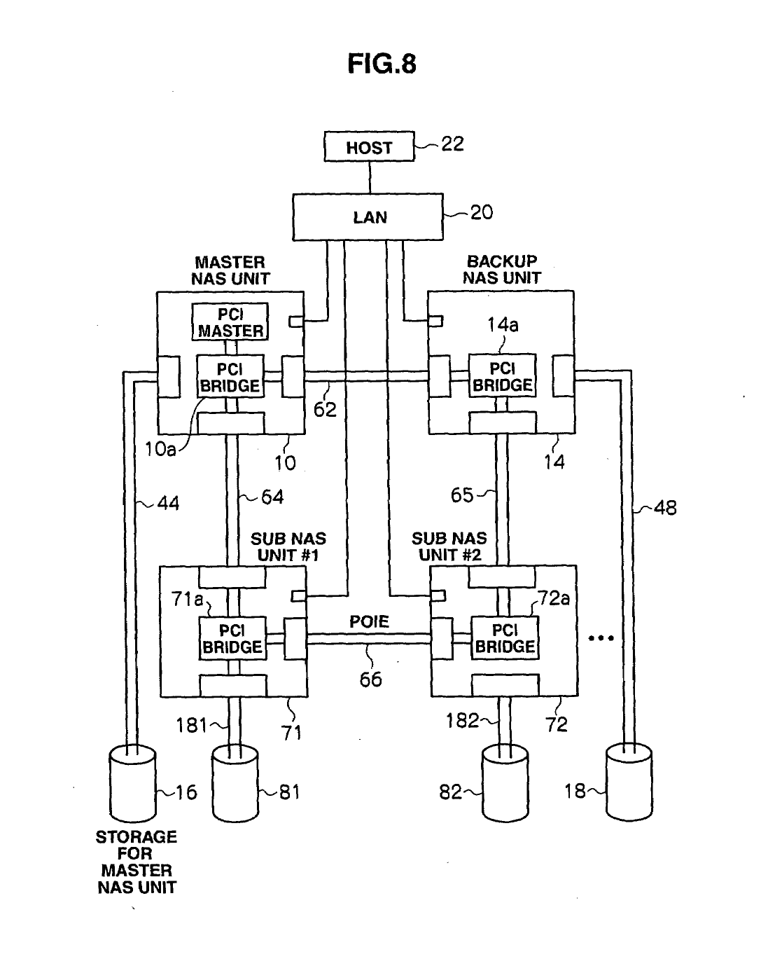

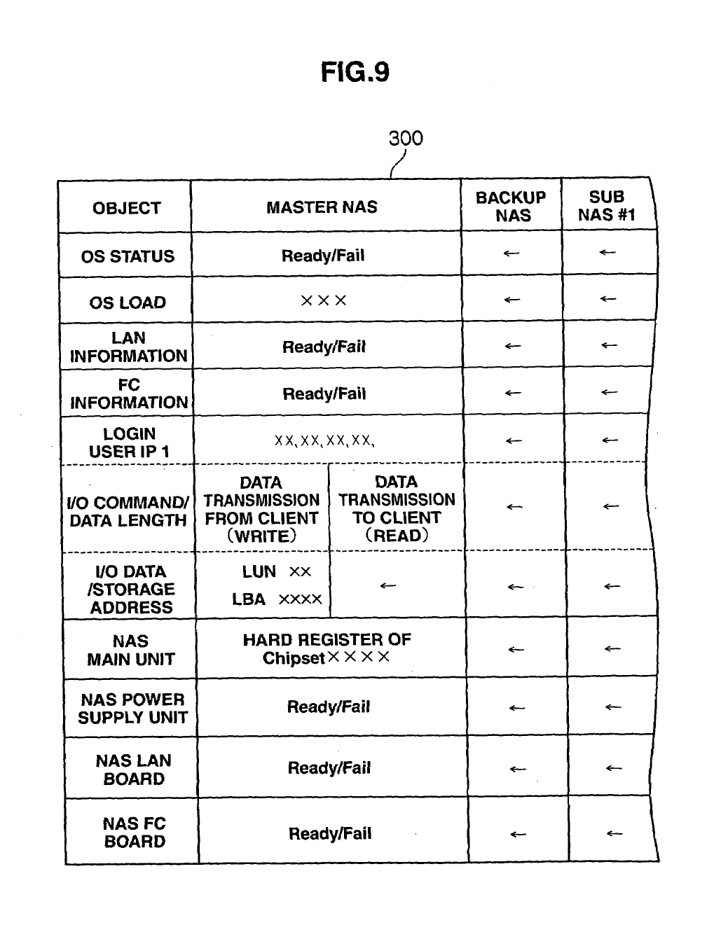

In the NAS system according to Embodiment 2, the system including the NAs unit 10 and storage apparatus16 is set as a master NAS system, the system including NAS unit 14 and disk storage apparatus 18 is set as a backup NAS system, the system including the NAS unit 71 and disk storage apparatus 81 is set as a subsystem #1, the system including the NAS unit 72 and disk storage apparatus 82 is set as subsystem #2, and the system including the NAS unit 7n and disk storage apparatus 8n is set as subsystem #n. The FC ports of the respective systems are connected to one another via the FC loop 36; the respective cable input/output ports are serially connected to one another via the PCI express cables 62, 64, 66, . . . and 6n; and the respective LAN ports 24, 28, 91 and 9n are connected to the LAN 20. The NAS units 71 to 7n are structured with the same components as the NAS unit 10 and the disk storage apparatus 81 to 8n are structured with the same components as the disk storage 16. The NAS units 71 to 7n and the disk storage apparatuses 81 to 8n are serially connected to one another via PCI express cables 181, 182 . . . and 18n. FIG. 8 shows a block diagram where the respective NAS units are PCI connected to one another. In the case of FIG. 8, PCI bridges 10a, 14a, 71a, . . . and 7na in the NAS units 10, 14, 71, . . . and 7n are connected to each other via PCI express cables 62, 64, 65, 66, . . . and 6n. FIG. 9 shows the structure of a monitor information table 300 used in the respective NAS systems.

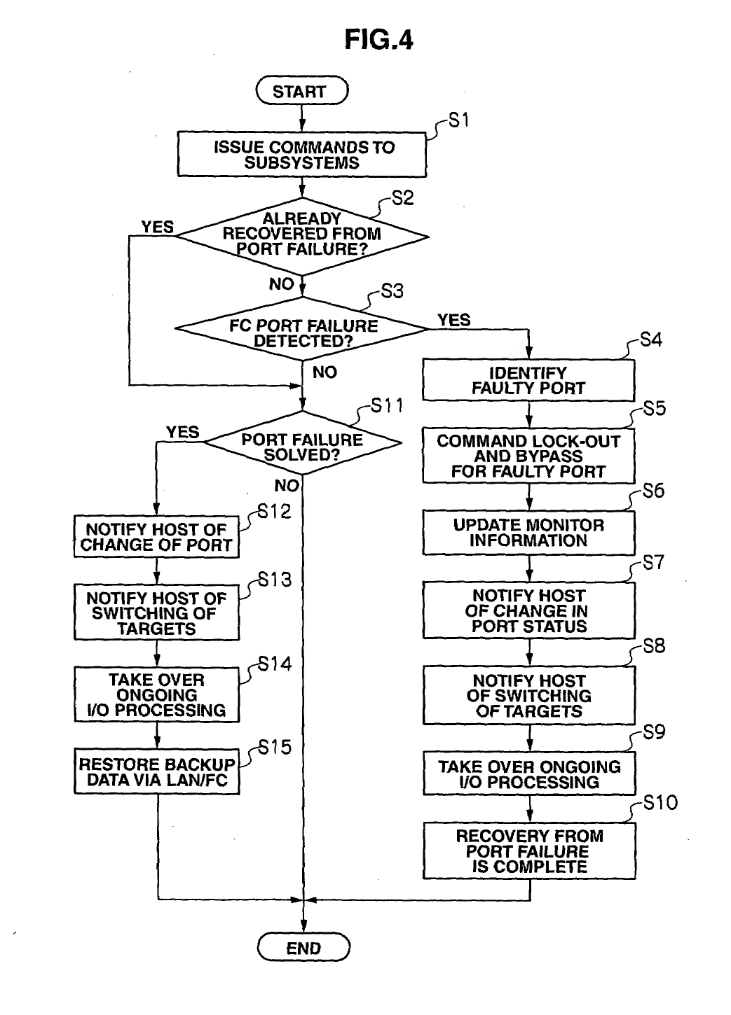

FIG. 4 is a flowchart of recovery processing performed when an FC failure—which includes port failure, driver failure, and logical hardware failure—occurs in the NAS system shown in FIG. 3.

First, in order to collectively manage the information for the subsystems, the CPU in the NAS unit 10 belonging to the master NAS system issues commands to the subsystems via the FC port 30 and FC loop 36 and checks responses to these commands (step S1). Then, the CPU in the NAS unit 10 judges whether the NAS system has already recovered from the port failure (step S2) and if the recovery from the port failure is not complete, it judges whether an FC port failure has occurred (step S3). The CPU in the NAS unit 10 analyzes the OS information 200 attached to the response to the command and, if an FC port failure is detected, it identifies the faulty port based on the OS information 200 (step S4). For example, if a port failure occurs in the subsystem #2, the CPU commands the NAS unit 72 belonging to the subsystem #2 to lock-out and bypass the faulty port (step S5). Then, triggered by the occurrence of the FC port failure, the CPU in the NAS unit 10 updates monitor information (step S6). It also notifies the host 22 that a port is changed, via the LAN 20 from the LAN port 24 (step S7).

Then, the NAS unit 72 belonging to the subsystem #2 notifies, via the LAN 20, the host 22 of the switching of communication targets; and transfers information processed at the time the failure occurred to the NAS unit 14 in the backup NAS system via the FC loop 36. Here, the NAS unit 72 also notifies the host 22 of the fact that the information processed at the time the failure occurred has been transferred to the backup NAS system (step S8). Then, as a step for port failure recovery, the NAS unit 14 in the backup NAS system takes over the ongoing I/O information processing (step S9). During a failure, I/O information processing is performed when, for example, the host 22—a client—writes data in a sub NAS system via the LAN 20. This processing includes retries for commands and I/O information. Then, the NAS unit 72 in the subsystem #2 notifies the NAS unit 10 in the master NAS system that the recovery from the port failure is complete (step S10). This is the end of the recovery from the port failure.

Meanwhile, after the end of the recovery from the port failure, if it is judged in step S2 that the recovery from the port failure is complete, the processing proceeds to step S11 where the NAS unit 10 judges whether the problem in the faulty port has been solved. If the problem has been solved, the NAS unit 10 notifies the host 22 of the port change (step s12). Then, the NAS unit 14 in the backup NAS system notifies the host 22 of the switching of targets (step S13). After that, the NAS unit 14 takes over the I/O information processing the NAS unit 72 was performing, thereby performing the system recovery processing (step S14). Then, the processing for restoring backup data from the NAS unit 14 in the backup NAS system to the disk storage 82 in the subsystem #2 via the LAN 20 or FC loop 36 is performed (step S15). Specifically, the backup data is restored to the disk storage apparatus 82 in the subsystem #2. Then, the processing in this routine is terminated.

According to Embodiment 2, when an FC failure occurs, the faulty port is locked out and bypassed so ongoing processing can continue. Accordingly, even if an FC failure occurs, the information for the subsystems can be collectively managed. Also, even if an FC failure occurs, the information processed at the time the failure occurred is saved in (transferred to) a backup NAS system and later, when the problem in the faulty port has been solved the data stored in the backup NAS system is restored to the original subsystem (the subsystem recovered from the FC failure) so that it can be recovered completely from the FC failure.

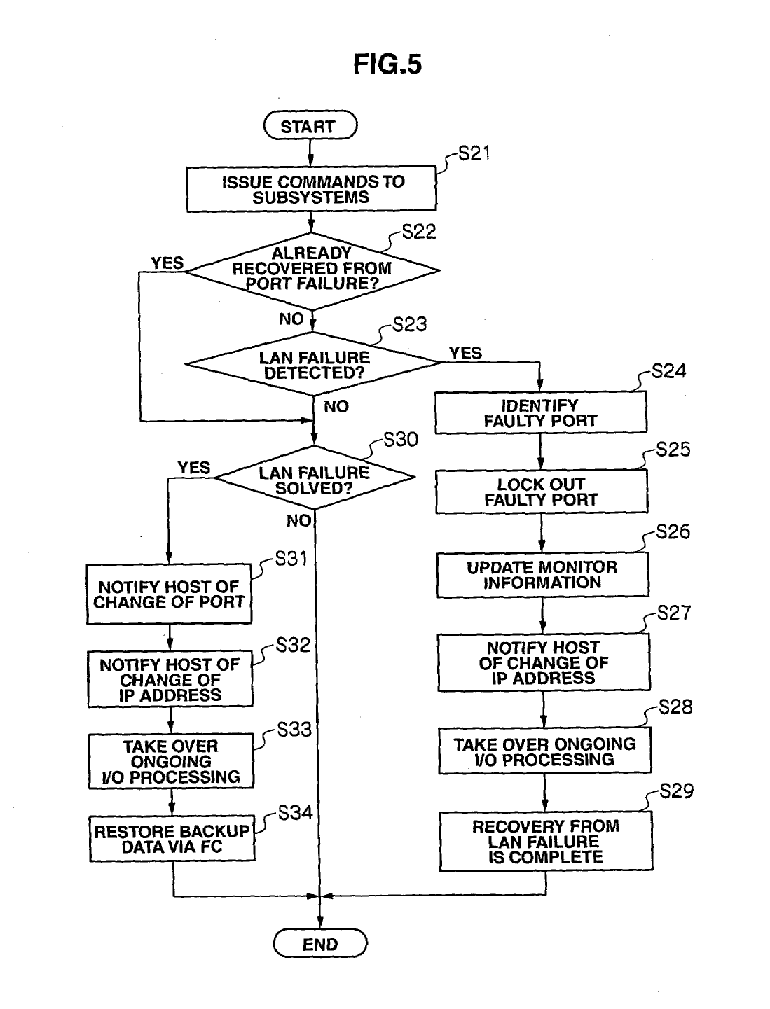

Next, recovery processing performed when a LAN failure (including port failure, driver failure, and logical hardware failure) occurs is explained with reference to the flowchart in FIG. 5. In FIG. 5, the same steps as steps S1 and S2 in FIG. 4 are performed in steps S21 and S22 but not in step S23 where, whether a failure has occurred in LAN 20 is judged. Also, when a LAN failure is detected in the LAN 20, the same steps as steps S4 and S5 are performed in steps S24 and S25. For example, when a LAN failure occurs between the subsystem #2 and LAN 20, the NAS unit 72 in the subsystem #2 is ordered to lock out and bypass its faulty port. Then, the CPU in the NAS unit 10 updates the monitor information due to the occurrence of the LAN failure (step S26). Then, the NAS unit 10 in the master NAS system notifies the host 22 of the change of an IP address (step S27). Thereafter, in order to process information at the time of occurrence of the failure, the NAS unit 14 in the backup NAS system performs processing with regard to I/O information 202, e.g., the processing where the host 22 writes data in any of the sub NAS systems via the LAN 20. Here, the processing includes retries for commands and I/O information. Then, just like the step S10 in FIG. 4, the NAS unit 72 in the subsystem #2 notifies the NAS unit 10 in the master NAS system that the recovery from the LAN failure is complete (step S29).

Meanwhile, when the recovery from the LAN failure is complete, it is judged in step S22 that the recovery from the LAN failure is complete and the NAS unit 10 judges whether the problem in the faulty LAN has been solved (step S30). Then, the NAS unit 10 notifies the host 22 of the change of port (step S31), and the NAS unit 14 in the backup NAS system notifies the host 22 of the switching of the IP address (step S32). Thereafter, the NAS unit 14 in the backup NAS system takes over the ongoing I/O information processing (step S33). Then, the backup data involved in the LAN failure is restored from the NAS unit 14 to the disk storage apparatus 82 in the subsystem #2 and the processing in this routine is ended.

According to FIG. 5, when a LAN failure occurs, the faulty port is locked out and bypassed in order to continue processing. Therefore, even if a LAN failure occurs, the information for the subsystems can be collectively managed. Moreover, even if a LAN failure occurs, the information processed at the time it occurs can be saved in the backup NAS system and when the problem in a faulty port has been solved, the data saved in the backup NAS system is restored to its original subsystem, and so the subsystem can recover from the LAN problem without fail.

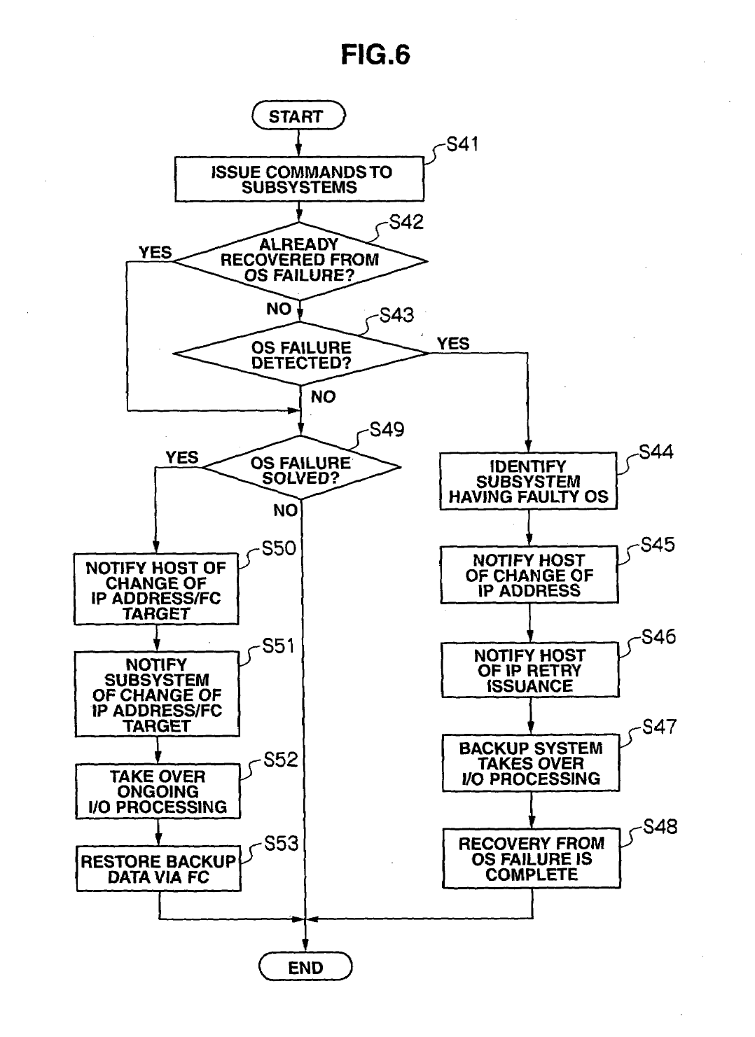

Recovery processing performed when an OS failure occurs will be explained with reference to the flowchart shown in FIG. 6. In FIG. 6, the same steps as the steps S21 to S24 in FIG. 5 are performed, but not in step 42, where it is judged whether a previous OS failure has been recovered from, and step S43 where it is judged whether an OS failure has occurred or not. When an OS failure is detected, the NAS unit 10 identifies the subsystem having the faulty OS (step S44). Then, the NAS unit 10 notifies the host 22 of the change of IP address (step S45) and also notifies the host 22 of the retry issuance of I/O information (step S46). Then, the NAS unit 14 in the backup NAS system takes over the ongoing I/O information processing (step S47). Then, when the recovery from the OS failure is complete, the subsystem having the faulty OS notifies the master NAS system of the fact that the recovery from the OS failure is complete (step S48).

Meanwhile, when the recovery from the OS failure is complete, it is judged in step S42 that the recovery from an OS failure is complete, and the NAS unit 10 judges whether the problem in the faulty OS has been solved (step S49). If the problem is solved, the NAS unit 10 notifies the host 22 of the change of an IP address/FC target (step S50). Thereafter, the NAS unit 14 in the backup NAS system notifies the system that has recovered, e.g., the subsystem #2, of the change of the IP address/FC target (step S51). Then, the backup NAS system takes over the ongoing I/O processing (step S52). Then, the backup NAS system restores the backup data to the system that has recovered from the failure (step S53) and the processing in this routine is ended.

According to FIG. 6, when an OS failure occurs, the subsystem having the faulty OS is identified and information at the time failure occurs is saved in (transferred to) the backup NAS system, then, when the problem in the faulty OS is solved, the data saved in the backup NAS system is restored to the source subsystem (subsystem recovered from the OS failure), thereby enabling the recovery of the subsystem from the OS failure with certainty.

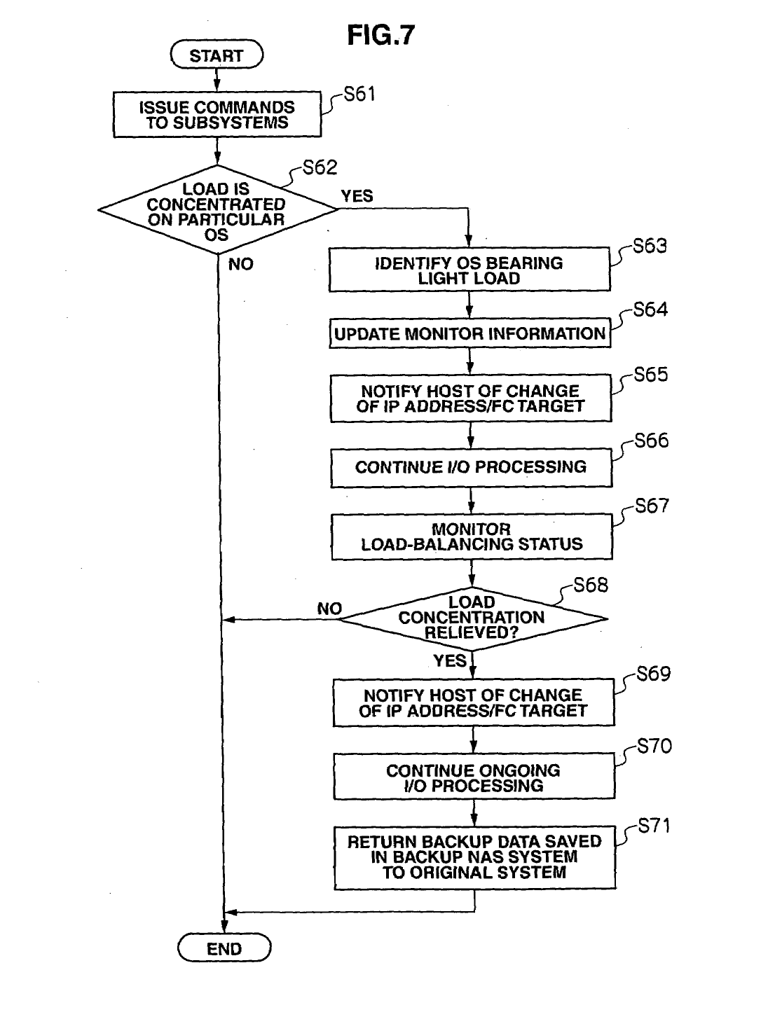

Load-balancing processing will be explained with reference to the flowchart shown in FIG. 7. First, the NAS unit 10 issues commands to the subsystems (step S61); checks responses from the subsystems; and judges whether a particular OS bears a concentrated load (step S62). If a particular OS bears a concentrated load, the NAS unit 10 identifies the OS bearing a light load based on the OS information (step S63). Then, triggered by the identification, the NAS unit 10 updates the NAS system monitor information (step S64), and notifies the host 22 of the change of IP address/FC target (step S65).

Then, the information the system with the OS bearing the concentrated load was processing at that time (backup data) is shared with the backup NAS system. The backup NAS system then processes the distributed information and this processing continues (step S66). Then, the NAS unit 10 monitors the load-balancing status (step S67), judges whether the load concentration has been relieved (step S68), terminates the processing in this routine if the load concentration is not relieved but if it is already relieved, the processing proceeds to step S69 where the NAS unit 10 notifies the host 22 of the change of an IP address/FC target. Then, the backup NAS system continues the ongoing I/O information processing (step S70), and because the load concentration has been relieved, the backup data saved in the backup NAS system is returned to the original system via the FC loop 36 (step S71) and the processing in this routine is then terminated.

According to FIG. 7, when a particular OS has a concentrated load, the subsystem having that OS is identified, some parts of the load are allotted to the backup NAS system, and when the load concentration is relieved, the information allotted to the backup NAS system is returned to the original subsystem, so the system can be operated smoothly even when the load is concentrated on one particular OS.

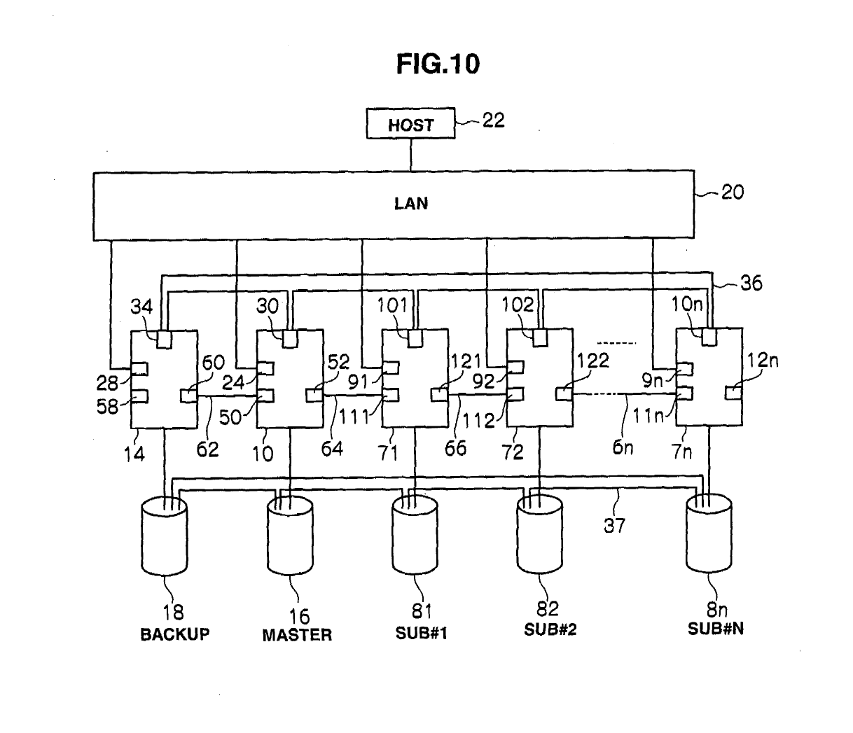

Embodiment 3 of this invention will be explained with reference to FIG. 10. In this embodiment, the disk storage apparatuses 16, 18, and 81 to 8n are loop-connected to one another so that when the host 22 intends to read data from one of the sub NAS systems and if that sub NAS goes down, the host 22 still can access the data. Other aspects of the system structure in Embodiment 3 are the same as in FIG. 3. Regarding the I/O information processing, when the host 22 writes data in one of the sub NAS systems, the same processing as that shown in FIG. 3 is performed, but when the host 22 reads data from one of the sub NAS systems, the processing described below is performed.

When the host 22 reads data from any one of the sub NAS systems, the NAS unit 10 in the master NAS system issues to the FC loop 37 a dedicated command having the # (number) of the access target sub NAS system and the information for the read target data (LUN#, LBA#) attached thereto. When this command is input to the respective disk storage apparatuses via the FC loop 37, the respective disk storage apparatuses process the command using their command devices, access the target data in the sub NAS system, and transfer the data to the master NAS system via the FC loop 37. The master NAS system transmits the transferred data to the host 22—client who asked for the data—via the LAN 20.

According to Embodiment 3, because the disk storage apparatuses 16, 18, and 81 to 8n are loop-connected via the FC loop 37, if one of the sub NAS systems the host 22 intends to read data from goes down, the host 22 still can read the data from the other sub NAS systems. In other words, the data read processing has high reliability.

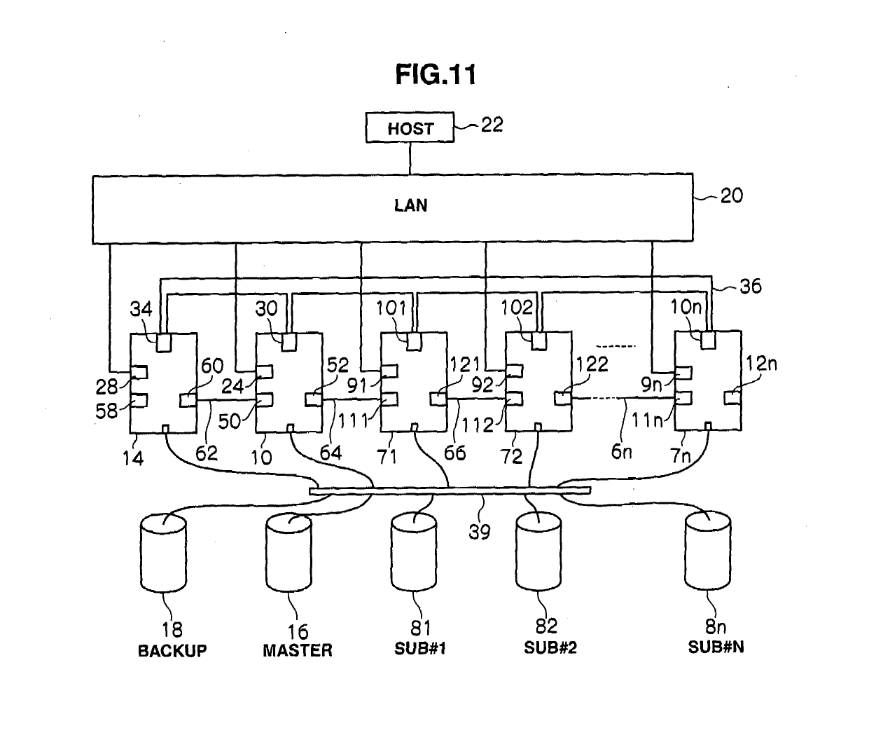

Embodiment 4 of this invention will be explained with reference to FIG. 11. In this embodiment, an FC switch 39 is provided and the respective NAS units 10, 14, and 71 to 7n and the respective disk storage apparatuses 16, 18, and 81 to 8n are connected to one another via this FC switch 39 so that if one of the sub NAS systems the host 22 intends to read data from goes down, the host 22 still can access the read target data. Other aspects of the system structure are the same as in FIG. 3. Regarding the I/O information processing, when the host 22 writes data in one of the sub NAS systems, the same processing as that shown in FIG. 3 is performed, but when the host 22 reads data from any of the sub NAS systems, the processing described below is performed.

When the host 22 reads data from one of the sub NAS systems, the NAS unit 10 in the master NAS system issues to the FC loop 37 a dedicated command having the # (number) of the access target sub NAS system and the information for the read target data (LUN#, LBA#) attached thereto. When this command is input to the respective disk storage apparatuses via the FC switch 39, the respective disk storage apparatuses process the command using their command devices, access the target data in the sub NAS system, and transfer the accessed data to the master NAS system via the FC switch 39. The master NAS system transmits the transferred data to the host 22—the client that asked for the data—via the LAN 20.

According to Embodiment 4, because the NAS units 10, 14, and 71 to 7n and the respective disk storage apparatuses 16, 18, and 81 to 8n are connected to one another via the FC switch 39, if one of the sub NAS systems the host 22 intends to read data from goes down, the host 22 still can read the data from the other sub NAS systems. In other words, the data read processing has high reliability.

Incidentally, the foregoing embodiments have been explained for the case where the storage devices are hard disks, but semiconductor memory such as flash memory may also be used as the storage devices.

What is claimed is:

1. A NAS system communicating with a host system via a communication network, having a plurality of NAS units that process information involved in the communication, being configured to be able to transmit/receive information to/from the respective NAS units, and controlling access from the host system to storage devices, wherein
each NAS unit has a network port connected to the communication network and a backend port connected to another NAS unit, and the respective NAS units are connected one another via the backend ports.

2. The NAS system according to claim 1, wherein the backend ports of the respective NAS units are Fibre Channel ports, and they are loop-connected to one another.

3. The NAS system according to claim 1, wherein the backend ports of the respective NAS units are cable input/output ports and they are serially connected to one another via a PCI EXPRESS cable.

4. The NAS system according to claim 1, wherein the backend ports of the respective NAS units are Fibre Channel ports or cable input/output ports, and the respective Fibre Channel ports are loop-connected to one another, and the respective cable input/output ports are connected to one another via a PCI EXPRESS cable.

5. The NAS system according to claim 1, wherein, of the plurality of NAS units, one is configured as a master NAS unit and the rest are configured as slave NAS units, and the master NAS unit collectively manages the slave NAS units by transmitting/receiving information to/from the slave NAS units via the respective backend ports based on system information.

6. The NAS system according to claim 1, wherein, of the plurality of NAS units, one is configured as a master NAS unit and the rest are configured as slave NAS units, and the master NAS unit monitors the statuses of the other NAS units by transmitting/receiving information to/from them via the respective backend ports based on system information and, based on the monitoring result, it processes information regarding load balancing or failure-period operations.

7. The NAS system according to claim 1, wherein, of the plurality of NAS units, one is configured as a master NAS unit, another is configured as a backup NAS unit and the rest are configured as sub NAS units, and the master NAS unit monitors the statuses of the other NAS units by transmitting/receiving information to/from them via the respective backend ports based on system information, and mirror-copies transferred information to a storage device in the backup NAS unit.

8. The NAS system according to claim 1, wherein, of the plurality of NAS units, one is configured as a master NAS unit, another is configured as a backup NAS unit and the rest are configured as sub NAS units, and the master NAS unit monitors the statuses of the other NAS units by transmitting/receiving information to/from them via the respective backend ports based on system information; and when an FC failure occurs in one of the other NAS units, it commands that NAS unit to lock out and bypass its faulty port, transfers the information that NAS unit was processing at the time the failure occurred to the backup NAS unit, and when the problem in the faulty FC is solved, restores the information saved in the backup NAS unit to the NAS unit recovered from the FC failure.

9. The NAS system according to claim 1, wherein, of the plurality of NAS units, one is configured as a master NAS unit, another is configured as a backup NAS unit and the rest are configured as sub NAS units, and the master NAS unit monitors the statuses of the other NAS units by transmitting/receiving information to/from them via the respective backend ports based on system information; and when a LAN failure occurs in one of the other NAS units, it commands that NAS unit to lock out and bypass its faulty port, transfers the information that NAS unit was processing at the time the failure occurred to the backup NAS unit, and when the problem in the faulty LAN is solved, restores the information saved in the backup NAS unit to the NAS unit recovered from the LAN failure.

10. The NAS system according to claim 1, wherein, of the plurality of NAS units, one is configured as a master NAS unit, another is configured as a backup NAS unit and the rest are configured as sub NAS units, and the master NAS unit monitors the statuses of the other NAS units by transmitting/receiving information to/from them via the respective backend ports based on system information; and when an OS failure occurs in one of the other NAS units, it transfers the information that NAS unit was processing at the time the failure occurred to the backup NAS unit, and when the problem in the faulty OS is solved, restores the information saved in the backup NAS unit to the NAS unit recovered from the OS failure.

11. The NAS system according to claim 1, wherein, of the plurality of NAS units, one is configured as a master NAS unit, another is configured as a backup NAS unit and the rest are configured as sub NAS units, and the master NAS unit monitors the statuses of the other NAS units by transmitting/receiving information to/from them via the respective backend ports based on system information; and when one of the other NAS units has a concentrated load, it identifies the NAS unit bearing the concentrated load, allots a part of the load to the backup NAS unit and, when the load concentration on that NAS unit is relieved, it returns the load from the backup NAS unit back to that NAS unit.

12. A method for processing information performed in a NAS system that communicates with a host system via a communication network, has a plurality of NAS units for processing information involved in the communication, and controls access to storage devices by transmitting/receiving information to/from the respective NAS units,
wherein each NAS unit includes a network port connected to the communication network and a backend port connected to the adjacent NAS units, the respective backend ports are connected to one another, one of the plurality of the NAS units is configured as a master NAS unit, another NAS unit is configured as a backup NAS unit, and the rest are configured as sub NAS units,
the method comprising:
a step in which the master NAS unit monitors the statuses of the other NAS units by transmitting/receiving information to/from them via the respective backend ports based on system information; and
a step in which the master NAS unit processes information regarding load balancing and failure-period operations based on the monitoring result.

13. A method for processing information performed in a NAS system that communicates with a host system via a communication network, has a plurality of NAS units for processing information involved in the communication, and controls access to storage devices by transmitting/receiving information to/from the respective NAS units,
wherein each NAS unit includes a network port connected to the communication network and a backend port connected to the adjacent NAS units, the respective backend ports are connected to one another, one of the plurality of the NAS units is configured as a master NAS unit, another NAS unit is configured as a backup NAS unit, and the rest are configured as sub NAS units,
the method comprising:
a step in which the master NAS unit monitors the statuses of the other NAS units by transmitting/receiving information to/from them via the respective backend ports based on system information; and
a step in which the master NAS unit mirror-copies transferred information in a storage device to the backup NAS unit.

14. A method for processing information performed in a NAS system that communicates with a host system via a communication network, has a plurality of NAS units for processing information involved in the communication, and controls access to storage devices by transmitting/receiving information to/from the respective NAS units,
wherein, each NAS unit includes a network port connected to the communication network and a backend port connected to the adjacent NAS units, the respective backend ports are connected to one another, one of the plurality of the NAS units is configured as a master NAS unit, another NAS unit is configured a backup NAS unit, and the rest are configured as sub NAS units,
the method comprising:
a step in which the master NAS unit monitors the statuses of the other NAS units by transmitting/receiving information to/from them via the respective backend ports based on system information;
a step in which, when an FC failure occurs in one of the other NAS units, the master NAS unit commands that NAS unit to lock out and bypass its faulty port;
a step in which the master NAS unit transfers the information that NAS unit was processing at the time the failure occurred to the backup NAS unit; and
a step in which, when the problem in the faulty FC is solved, the master NAS unit restores the information saved in the backup NAS unit to the NAS unit that has recovered from the FC failure.

15. A method for processing information performed in a NAS system that communicates with a host system via a communication network, has a plurality of NAS units for processing information involved in the communication, and controls access to storage devices by transmitting/receiving information to/from the respective NAS units,
wherein, each NAS unit includes a network port connected to the communication network and a backend port connected to the adjacent NAS units, the respective backend ports are connected to one another, one of the plurality of the NAS units is configured as a master NAS unit, another NAS unit is configured as a backup NAS unit, and the rest are configured as sub NAS units,
the method comprising:
a step in which the master NAS unit monitors the statuses of the other NAS units by transmitting/receiving information to/from them via the respective backend ports based on system information;
a step in which, when a LAN failure occurs in one of the other NAS units, the master NAS unit commands that NAS unit to lock out and bypass its faulty port;
a step in which the master NAS unit transfers the information that NAS unit was processing at the time the failure occurred to the backup NAS unit; and
a step in which, when the problem in the faulty LAN is solved, the master NAS unit restores the information saved in the backup NAS unit to the NAS unit that has recovered from the LAN failure.

16. A method for processing information performed in a NAS system that communicates with a host system via a communication network, has a plurality of NAS units for processing information involved in the communication, and controls access to storage devices by transmitting/receiving information to/from the respective NAS units,
wherein, each NAS unit includes a network port connected to the communication network and a backend port connected to the adjacent NAS units, the respective backend ports are connected to one another, one of the plurality of the NAS units is configured as a master NAS unit, another NAS unit is configured as a backup NAS unit, and the rest are configured as sub NAS units,
the method comprising:
a step in which the master NAS unit monitors the statuses of the other NAS units by transmitting/receiving information to/from them via the respective backend ports based on system information;
a step in which, when an OS failure occurs in one of the other NAS units, the master NAS unit transfers information that NAS unit was processing at the time the failure occurred to the backup NAS unit; and
a step in which, when the problem in the faulty OS is solved, the master NAS unit restores the information saved in the backup NAS unit to the NAS unit that has recovered from the OS failure.

17. A method for processing information performed in a NAS system that communicates with a host system via a communication network, has a plurality of NAS units for processing information involved in the communication, and controls access to storage devices by transmitting/receiving information to/from the respective NAS units,
wherein, each NAS unit includes a network port connected to the communication network and a backend port connected to the adjacent NAS units, the respective backend ports are connected to one another, one of the plurality of the NAS units is configured as a master NAS unit, another NAS unit is configured as a backup NAS unit, and the rest are configured as sub NAS units,
the method comprising:
a step in which the master NAS unit monitors the statuses of the other NAS units by transmitting/receiving information to/from them via the respective backend ports based on system information;
a step in which, when one of the other NAS units has a concentrated load, the master NAS unit identifies that NAS unit bearing the concentrated load and allots a part of the load to the backup NAS unit; and
a step in which, when the load concentration on that NAS unit is relieved, the master NAS unit returns the load from the backup NAS unit back to the particular NAS unit.
